(19) United States
(12) Patent Application Publication
(10) Pub. No.: US 2013/0008559 A1
(43) Pub. Date: Jan. 10, 2013

(54) Device and Apparatus for Dispensing a Liquid Under Pressure

(75) Inventor: Jens Kristian Stig Andersen, Aarhus (DK)

(73) Assignee: JENS KSA HOLDING APS, Aarhus (DK)

(21) Appl. No.: 13/515,009

(22) PCT Filed: Dec. 10, 2010
(86) PCT No.: PCT/DK2010/050335

§ 371 Date: Sep. 17, 2012

(30) Foreign Application Priority Data
Dec. 11, 2009 (DK) PA 2009 70249

(51) Int. Cl. F16K 13/00; B65B 3/34; B65B 3/04

(52) U.S. Cl. 141/90; 141/181; 141/94; 137/798

(57) ABSTRACT

Device for dispensing a liquid under pressure where said device comprises connection means for connecting said device to the source of liquid, and where the device in the opposite end of the connection means has an outlet body which outlet body may be brought into a closed position where no liquid is dispensed, and an open position where liquid is dispensed, which outlet body incorporates a separate valve body cooperating with a valve seat, where said valve body has a head portion and a stem portion, where said stem portion in the closed position extends out of an opening in said outlet body, and where a lower surface of said head portion in the closed position is in contact with said valve seat and in said open position is out of contact with said valve seat.

### FIELD OF THE INVENTION

The present invention relates to a device for dispensing a liquid under pressure as well as an apparatus for issuing multiple portions of a liquid under pressure incorporating at least one device according to the invention.

### BACKGROUND OF THE INVENTION

In the art a number of devices have been designed in order to dispense a liquid under pressure, such as for example soft drinks or beer. One such example is disclosed in EP 0077910 in which an issuing nozzle is disclosed. The nozzle comprises an outer tubular member and an inner tubular member arranged coaxially one inside the other. The inner coaxial member is provided with a resilient sealing element at a distal end and the outer tubular member has been provided with a nozzle shaped open-end. By displacing the inner tubular member relative to the outer tubular member along the common access the resilient member will be brought into or out of contact with the outlet opening in the outer tubular member whereby liquid flow will be opened or closed depending on the position of the inner tube relative to the outer tube. The inner tube is activated for example by electromagnetic means pulling the inner tube up relative to the outer tube. The nozzle may therefore be activated anywhere by activating the electromagnetic means.

Substantially similar devices or constructions are known from GB 2447920 or U.S. Pat. No. 4,533,070. The nozzle arrangements in these three prior art disclosures are more or less equivalent and all rely on for example magnetically activated means in order to open or close the issuing nozzle.

GB2369817 disclose a dispenser handle for use when dispensing liquids such as strong spirits from a bottle. The handle comprises a reservoir into which a predetermined volume of liquid is filled. The filling is regulated by a ball valve system internally in the handle/reservoir. By activating a lever (handgrip) a central stem arranged inside the reservoir is elevated. The distal end of the stem is provided with a valve body, which cooperates with a valve seat near the outlet in order to open or. close the outlet from the reservoir. The stem is hollow at the distal end in order to allow air to enter the reservoir, making it possible for the liquid in the reservoir to escape. The lever further have the function of manipulating the stem such that the ball valve is opened/closed in order to allow further volumes of spirit into the reservoir.

This construction is specifically designed for spirits having no or very little sugar content, in that it is impossible to clean the interior of the reservoir, without completely dismantling the device. Spirits having a high alcohol content will not pollute the mechanism. Furthermore other liquids as for example soft drinks and beer having a sugar content will relatively quickly clog up the interior of the device, due to the fact that especially sugar substances will adhere to the interior surfaces inside the reservoir—thereby render the device useless.

From U.S. Pat. No. 5,603,363 is an apparatus known for dispensing liquids into containers such as cups and the like. The container must be equipped with a magnetic marker, such that as the container is placed around the issuing nozzle of the device, the magnetic marker will be recognized by a sensor on the apparatus, whereby the apparatus will open the issuing nozzle and issue the liquid into the container. The liquid will be issued as was the case with the devices mentioned above relatively close to the bottom of a container.

In WO 0152621 is disclosed an apparatus for dispensing a carbonated beverage, such as for example a soft drink or beer, where the apparatus comprises a dispensing nozzle which nozzle at a distal end is provided with electric or electronic switch means which when encountering the bottom of a container activates a controller in the apparatus. The controller carries out a number of processes before the liquid is dispenses such as for example reducing the pressure in the liquid to be dispensed which is forwarded beforehand to an intermediate reservoir. The apparatus furthermore includes an elevator for the container such that the container for example in the shape of a cup may be placed on the elevator and the apparatus activated in order to dispense liquid. After activation the cup is elevated until the bottom of the cup comes into contact with the electronic switch means arranged in the distal end of the nozzle. The liquid in the intermediate reservoir is pressure reduced to a suitable pressure close to atmospheric pressure after which the liquid is dispensed into the cup. After the dispensing has terminated, the elevator lowers the now filled cup and makes it available for the user.

### OBJECT OF THE INVENTION

It is the object of the present invention to provide a device for dispensing a liquid which has a very simple construction, simple activation means and is very reliable in use. Furthermore, it is also an object of the present invention to provide a device which is easy to clean and thereby makes it possible to obtain a very high hygienic standard.

The invention also aims at providing an apparatus by which it is possible to issue multiple beverages simultaneously.

### DESCRIPTION OF THE INVENTION

The invention addresses this by providing a device for dispensing a liquid under pressure where said device comprises connection means for connecting said device to the source of liquid, and where the device in the opposite end of the connection means has an outlet body which outlet body may be brought into a closed position where no liquid is dispensed, and an open position where liquid is dispensed, which outlet body incorporates a separate valve body cooperating with a valve seat, where said valve body has a head portion and a stem portion, where said stem portion in the closed position extends out of an opening in said outlet body, and where a lower surface of said head portion in the closed position is in contact with said valve seat and in said open position is out of contact with said valve seat.

By providing a valve body as a completely separate member which is mechanically activated by for example bringing the bottom of a container into contact with the stem portion of the valve body, a very simple and reliable mechanism is provided. Furthermore, from a cleaning perspective it is relatively easy to clean the outlet body containing the valve seat and the valve body, whereas for example looking to the prior art as discussed above with reference to WO 0152621 and GB2369817 a number of interior surfaces of the device, are very difficult to access.

Furthermore, by having a valve seat engaging the lower portion of the head of the valve body it is ensured that the pressure originating from the pressurized liquid will force the valve body effectively into contact with the valve seat, when the valve body is not elevated, for example by contact with the bottom of a container. The prior art device relies on a closure between an upper part of the valve body and a coaxially arranged tubular member or that the valve body is withdrawn into the tubular member and by means of an O-ring provides sufficient sealing action against an interior wall of a tubular member. Both these arrangements have to counter the pressure in the beverage to be dispensed whereas the present invention uses the pressure in the liquid in order to force the valve body against the valve seat and thereby attain a simple and reliable closing.

With a device according to the invention it is furthermore achieved that a very fast opening of the dispensing valve is achieved. This is important in that the sooner a laminar flow (or substantial laminar) is achieved the less foam is generated. As the object is to provide liquid dispensation, the foam generation shall be avoided, apart from the desired foam generation, as will be further explained below. By activating the device according to the invention, by engaging the outlet body with the bottom of the container in which the liquid is to be dispensed, it is achieved that the valve is opened completely, in that an operator will intuitively force the outlet body into contact with the bottom of the container and thereby, completely and almost instantly elevate the valve body relative to the valve seat.

A further advantage compared to prior art devices is the arrangement of the valve body relative to the outlet body. By extending the stem of the valve body through an opening in the outlet body, the opening also serves as guidance for the valve body's movements relative to the valve seat. In this manner it is achieved that the valve body will be correctly placed relative to the valve seat and thereby effectively close the valve. A simple construction, yet effective.

Furthermore, the device according to the invention is connectable directly to the source of liquid under pressure, for example a keg of beer, and as such is a very simple device.

The underlying principle of the present invention therefore basically differs from the cited prior art in that activation of the device is achieved by inserting the outlet portion of the device into a container into which it is desirable to dispense a liquid. By engaging a surface of the container, typically the bottom, with the stem of the valve body the valve is opened.

In a further advantageous embodiment of the invention the device has a longitudinal axis where said outlet body is arranged coaxially around said axis, and an inner cavity is arranged inside said outlet body where said cavity has one or more outlet openings downstream from said valve seat and an opening coaxial with the axis for allowing the stem portion of the valve body to extend to the exterior of said outlet body where said cavity has a size allowing the valve body to move freely along the axis a predetermined distance.

By allowing the stem portion of the valve body to extend to the exterior of said outlet body, preferably downwards, the valve body may be moved by being brought into contact with for example the bottom of a container in which the beverages is to be dispensed.

By furthermore maintaining the valve body inside a cavity where the cavity is dimensioned to allow the valve body to move freely and at the same time allowing the liquid under pressure to flow past the valve body, it is possible to control the dispensation of the liquid by designing the cavity appropriately such that the valve body in combination with the cavity will provide a substantially laminar flow. Furthermore, the outlet openings below the valve seat foresee that the liquid is issued very close to the bottom radially from said longitudinal axis towards the sides of the container in which the liquid is to be dispensed. In this manner it is achieved that it is possible to dispense the liquid very quickly i.e. an average pint glass may be filled in 2-5 seconds.

Traditionally, by dispensing for example beer from hand operated taps the filling of a pint glass usually takes place in stages in that the bartender has to wait while the foam generated by the first filling subsides such that a topping up action may be carried out in order to fill the glass to the required limit. Altogether this process may take a minute or more which substantially slows down business as compared to the present invention.

In a still further advantageous embodiment of the invention the valve body due to the pressure in the liquid will be urged against the valve seat and thereby the closed position, where when the stem portion of the valve body is pressed towards the outlet body the valve head will be forced out of contact with the valve seat, thereby allowing liquid to issue from the outlet body.

As already explained above, the pressure in the liquid will urge the lower surface of the valve head portion against the valve seat guided by the stem portion in the opening in the outlet body thereby efficiently creating a closed valve. As the stem portion of the valve body extends outside the outlet, mechanical influence on the stem portion will cause the lower surface of the valve body's head portion to be lifted from the valve seat whereby it is possible for the liquid to issue.

A general problem when dispensing liquids under pressure, for example soft drinks and beer, is the fact that these liquids are usually carbonated such that as they are dispensed they will have a tendency to generate foam. In order to avoid foam generation the prior art WO 0152621 provides for an equalizing chamber as an intermediate storage for the beverage where the pressure inside the liquid is lowered prior to the dispensation. By lowering the pressure, part of the CO2 in the liquid will disappear which to a user will result in a relatively “flat” drink. It is therefore desirable to dispense the drink at a pressure, where the CO2 in the liquid is maintained dissolved in the liquid as long as possible and in a manner such that excessive foam generation is avoided. With the present invention this is achieved by providing a substantially laminar flow through the device out through the outlet openings and past the valve body.

In a further advantageous embodiment of the invention the flow area through the device and in particular through the outlet body is between 0.5 to 4 times more preferred 1 and 2 times the flow area of the inlet in the connection means. When designing the parts of the device in which liquid flow occurs within these limits it is ensured that the flow rate/velocity does not increase through the device, whereby pressure drops will not occur through the device, as provided by Bernoullis theories. Within the range of areas indicated above the foam generation through the device will be relatively minimal, without sacrificing flow speed of carbonated drinks. Normally an increase in flow rate will result in increased foam generation. Foam, although desirable in a limited and controlled amount, is not desired if all dispensed liquid is turned into foam. It is therefore desirable to maintain a relatively high liquid flow in combination with a relatively minimal foam generation, as will be provided within these design parameters.

In a further advantageous embodiment of the invention a resilient member is arranged coaxially with the longitudinal axis on the outside of the outlet body, at least partially surrounding the opening allowing the valve stem to extend from the outlet body.

The resilient member serves to protect the container into which the liquid is to be dispensed in that the outlet body may advantageously be made from stainless steel and as such, when being brought into contact with for example a glass container, may cause damage. This is especially true due to the rapid rhythm of dispensation such that the exchange of containers takes place relatively fast whereby the risk of damage increases. Furthermore, the resilient member also serves to ensure that a certain distance is kept between the bottom of the container and the lowermost surface of the outlet body.

In a still further advantageous embodiment the resilient member is compressible, where when the resilient member engages a surface, the valve head is lifted a predetermined distance from the valve seat, allowing the liquid to flow in a substantially laminar flow, whereas when the resilient member is compressed, the valve head will be in a position near the upper limit of the inner cavity, thereby creating a turbulent flow in the liquid flow.

This embodiment is particularly interesting in that by designing the cavity correctly it is possible to dispense pressurized liquid such as for example beer, first as a laminar flow and after compressing the resilient member creating a turbulent flow whereby foam is generated. In this manner it becomes possible to design the beverage such that it has a suitable head of foam without substantially slowing down the process of dispensing the beverage.

This is achieved by providing a cavity having an extent along the longitudinal axis of the device such that as the device is brought into contact with the bottom of a container, the valve body's stem engages the bottom of the container thereby elevating the lower surface of the valve body's head portion from the valve seat whereby liquid under pressure is dispensed as discussed above. By creating the right distance between the lower surface of the head portion of the valve body and the valve seat it can be ensured that a substantially laminar flow is provided. By further depressing the device relative to the bottom of the container thereby compressing the resilient member the valve body's head portion will be further displaced in the cavity. By designing the cavity's height relative to the valve stem such that when the resilient member is fully compressed, only a very narrow gap exists between the upper surface of the valve body's head portion and the upper part of the cavity, the narrow gap creates a pressure drop according to Bernoulli's equation. This pressure drop will release the CO₂ in the beverage whereby foam is generated and issued through the outlet openings in the outlet body. In this manner it is possible to control the foaming action simply by compressing the resilient member and thereby provide a beverage with an appropriate head of foam if so desired.

In a further advantageous embodiment the upper part of the valve head is at least partly convex, and that dimples, notches, grooves and/or ridges are provided on said upper part. This configuration of the upper part of the valve head is especially interesting in the embodiment described above where it is desirable to generate foam. The configuration of the upper part of the valve head may be used to enhance the foam generation. In this manner it becomes possible to increase the rate of dispensation and at the same time generate foam due to the unevenness of the upper part of the valve head.

In a still further advantageous embodiment of the invention the connection means comprises a bayonet coupling incorporating an activable one way valve, whereby the device may be separated or connected from the source of liquid.

Typically, the device will be manufactured from stainless steel, and by being able to detach the device at the connection means it is possible to place the device for example in a dishwasher whereby a thorough cleaning of the device may be achieved or to replace it if for one reason or another a malfunction occurs. Similarly, it may be that various size cavities and outlet openings may be especially suitable for various types of liquids and therefore it may be desirable to have various devices ready depending on the liquids to be dispensed.

Also contemplated within the scope of protection it is foreseen that the device as such may be manufactured from plastic more or less for one time use only which is to be understood as for example if a device according to the invention is used at a theatre, concert hall or other one day event, it may be possible just to discharge the device after use or after an appropriate time interval and install fresh clean devices such that all hygienic issues may be addressed simply by discarding the devices after use and replacing with fresh, clean devices. As the device is relatively simple in its construction and may be manufactured as injection moulded parts, the cost of the device may be maintained at a relatively low level making it feasible to discard the devices without a significant expense which would be the case if the device was manufactured from stainless steel or other more expensive material and process.

In a still further advantageous embodiment a stem portion is provided between said outlet body and said connection means, where said stem portion has a liquid conduit. The stem portion serves to allow the outlet body to be placed in contact with the bottom of the container even for containers which are relatively high such that the connection means, for example as will be described below, may be incorporated in a handle which under normal use should be kept out of the container and the liquid which is to be dispensed. The length of the stem portion may be adapted to the container's size/height or may be of a sufficient standard length such that various sizes of containers may be used.

The invention is also directed at an apparatus for issuing multiple portions of a liquid under pressure incorporating at least one device as described above wherein one or more devices are mounted in a vertically moveable holder along the longitudinal axis of the device, where the apparatus comprises means for moving the one or more devices into a position in a corresponding plurality of containers arranged in an array underneath the devices, where the projecting valve stem engages the bottom of said containers, whereby the valve head is lifted free from the valve seat and the outlet body issues pressurised liquid in the container, and to a position where the outlet body of the device is above the rim of said containers.

Due to the possibility of issuing the liquid very rapidly from each device it is also possible to rationalize the issuing of a liquid, for example by incorporating a plurality of devices. In practice, an apparatus incorporating six devices has been operated successfully. In order to place the containers at the correct positions, a container holder was used such that six glasses were arranged in the holder, placed underneath the apparatus and six seconds later six pints of beer were dispensed and the apparatus was ready for the next glass holder etc. The movement of the containers relative to the apparatus may be that the containers are moved upwards until they engage the valve stem extending from the outlet body or that the apparatus moves downwards towards the containers, for example placed on a table top surface, until the valve stem engages the bottom of the containers. For some types of liquid it is advantageous to elevate the container, whereas for other types it may be advantageous to lower the apparatus relative to the containers.

In order to enhance and increase the usability of the apparatus a flow meter or a timer is connected to the outflow of liquid from the source, such that only a predetermined amount of liquid is dispensed by the devices. In this manner it becomes possible to automatically dispense liquid simply by pressing a button whereby the containers are brought into engagement with the valve body and a predetermined amount of liquid is dispensed into the containers.

It is also contemplated that the apparatus according to the invention is provided with a washing station where the outlet body is withdrawn into said washing station in the apparatus, where said station substantially surrounds the outlet body and, if provided also at least part of the stem, where said washing station either comprises a number of nozzles positioned to wash the outlet body's exterior and stem, the outlet openings, and the inner cavity, or where a source of UV light is arranged for treating all surfaces of the outlet body, the valve body and the stem if provided.

As some beverages contain relatively high amounts of sugar, the sugar will act as a glue whereby the valve body will become glued to the inside of a cavity in the outlet body. For this purpose it is advantageous periodically to clean and wash the outlet body whereby prolonged consistent use is ensured. In order to avoid any contamination from bacteria and the like, the washing station may also advantageously be provided with a source of ultra-light which is known to kill bacteria and other germs.

In a further embodiment of the invention a relief spring is arranged between the valve body and the outlet body, where said relief spring urges the valve body against the liquid pressure, i.e. away from the valve seat. By providing such a relief spring the dispensation of liquid from the device is eased. Typically, when dispensing beer, the pressure in the beer tank will be for example 3 bars. For the test devices manufactured according to the invention, this translates into a 5 kg force on the distal end of the valve stem. This in turn means that in order to activate the device, i.e. elevated the valve body from the valve seat, an operator has to use at least 5 kg force downwards against the bottom of the container into which the liquid is to be dispensed. The 5 kg force may tire the operator and may damage the bottom of the container. Naturally if the pressure in the beer tank is higher an even larger force is needed.

The relief spring will be balanced such that only a minimum pressure will be needed in order to elevate the valve body from the valve seat. In further embodiments the relief springs force may be adjusted on site, such that the spring force may be adjusted according to the local circumstances. The pressure in the beer tank may also change over time during use, such that it may become necessary to adjust the relief springs force during use.

### DESCRIPTION OF THE DRAWING

The invention will now be explained with reference to the accompanying drawings wherein

FIG. 1 illustrates a device including a handle

FIG. 2 illustrates a cross section through the device of FIG. 1

FIGS. 3-5 illustrate various stages in the opening/closing of the valve

FIGS. 6-7 illustrate embodiments of suitable apparatuses

FIGS. 8-9 illustrate automated dispensation apparatus.

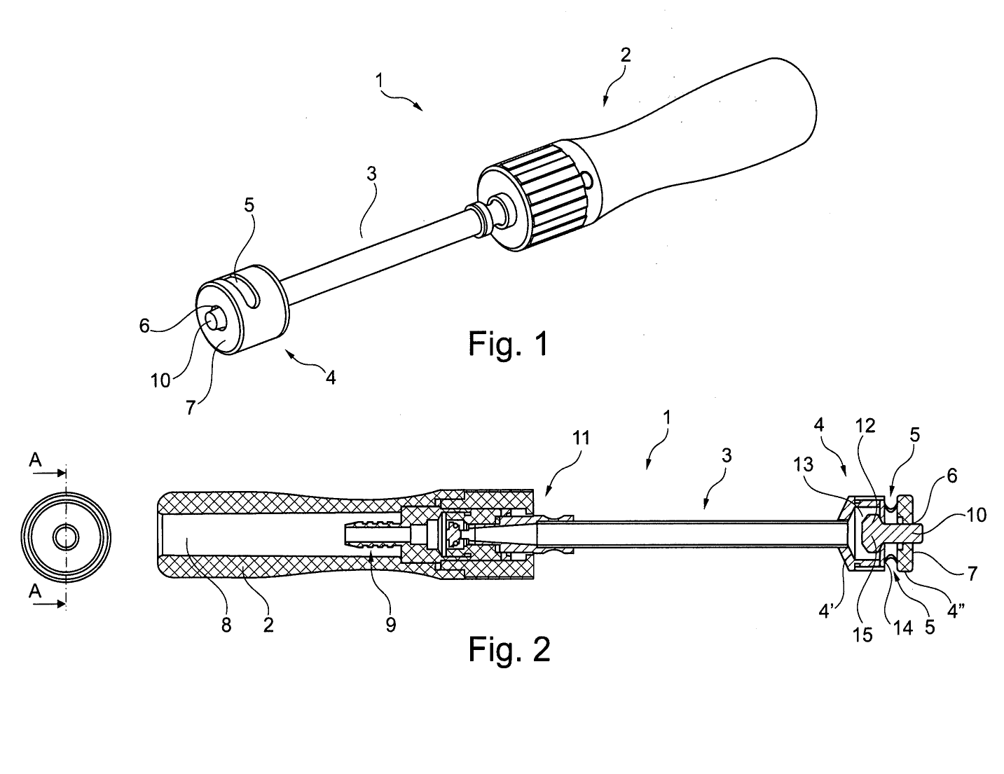

In FIG. 1 is illustrated a preferred embodiment of the invention. The device 1 comprises a handle 2, a stem portion 3 and an outlet body 4.

The handle is preferably made from a plastic material, injection moulded and with a size which is comfortable in use, but apart from these requirements the handle may be manufactured from any material and in any shape or form which the user might find suitable.

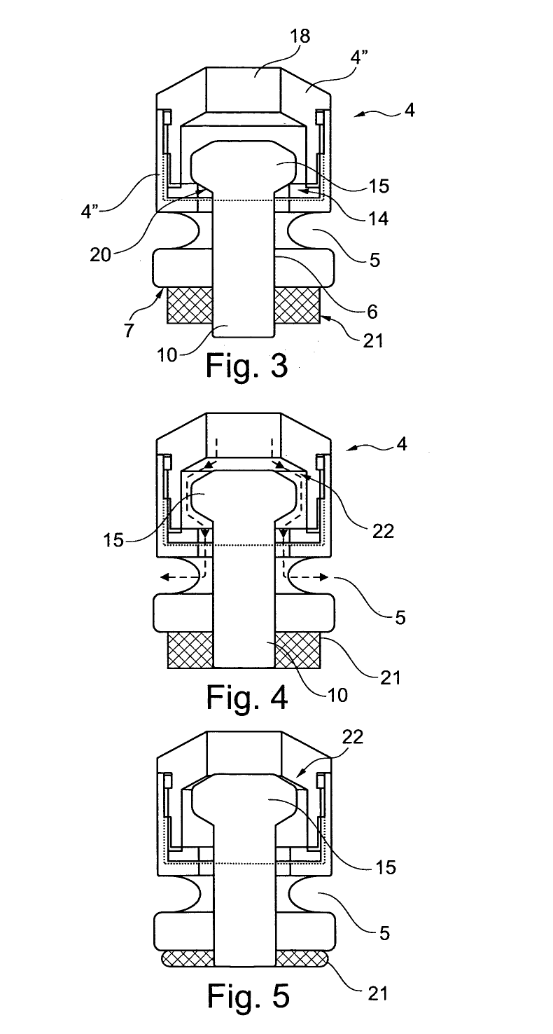

The stem 3 has a length such that it is possible to place the outlet body 4 in contact with the bottom of a canister or glass without immersing the entire device into the canister or dispensed liquid. The connection between the handle and the stem is preferably detachable as will be explained with reference to FIG. 2, but it is also foreseen that non-detachable stems may be used in connection with a handle.

The outlet body 4 is provided with an outlet opening 5 as well as an opening 6 in a bottom face 7 of the outlet body 4. The stem portion 10 of a valve body (not illustrated) projects out through the opening 6 in the outlet body 4. By inserting the device 1 into a canister in such a manner that the bottom portion 7 will come into contact with the bottom of the container, the projecting part of the valve stem 10 will be forced into a position where the bottom of the valve stem 10 is at the same level as the bottom portion 7 of the outlet body.

In FIG. 2 is illustrated a cross section through the device representing an embodiment of the invention as depicted in FIG. 1. Inside the handle 2 is provided a cavity 8. At the bottom of the cavity 8 is provided hose/tube connection means 9. A flexible hose may be connected in a traditional manner. The stem 3 is provided with a bayonet coupling 11 whereby the stem may be pushed into and rotated relative to the handle 2 whereby the stem is released. Inside the coupling 11 is provided sealing rings etc. in order for the connector to shut off the liquid flow once the stem is being prepared to be released. In this connection it is important that the connector shuts off liquid flow before the stem is removed in order to avoid spillage of liquid.

Opposite the handle is the outlet body 4 provided. In this embodiment the outlet body is made from two parts 4′, 4″ which after the valve body 12 is arranged in the cavity 13 are squeezed together.

The valve body 12 is provided with a head portion 15 and a stem portion 10. As illustrated the stem portion 10 projects outside the bottom surface 7 of the outlet body through an opening 6.

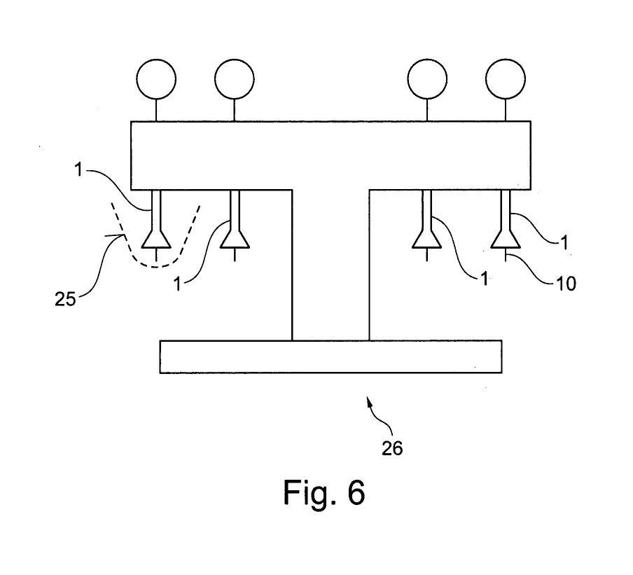

In the cavity 13 there is sufficient space such that the valve body 12 may move (to the left in the figure) as the stem portion 10 is urged towards the bottom part 7 of the outlet body 4. In the illustrated position the liquid in the stem and in the cavity will urge the underside of the head portion 15 towards the valve seat 14 as will be explained with reference to FIGS. 3-5.

Furthermore, outlet openings 5 are provided in the outlet body 4.

Turning to FIG. 3-5 the outlet body 4 will be explained in more detail.

In FIG. 3 the outlet body 4 is illustrated in its closed position. The lower face of the valve body's head part 15 is in contact with the valve seat 14.

In the upper part 4′ of the outlet body 4 is provided an opening 18 which is intended for fastening of the stem, see FIG. 1 or 2.

In the position illustrated in FIG. 3 the valve is closed in that the lower face 20 of the valve body 15 is in contact with the valve seat 14. Above the valve body 15 will be an overpressure in the cavity surrounding the valve body corresponding to the pressure in the pressurized liquid.

Attached to a lower surface 7 of the outlet body 4 is a resilient member 21. In the illustrated embodiment the resilient member is a sponge-like material in the shape of a ring which encloses the valve stem 10. In other embodiments the resilient member may be a (helical) spring or any other suitable construction. The valve stem 10 extends outside the resilient member 21. The resilient member may in other embodiments be a number of separate pieces arranged coaxially around the opening 6 through which the valve stem 10 extends.

Turning to FIG. 4 the valve stem 10 has been pushed upwards to a level where the bottom of the valve stem 10 is at the same level as the underside of the resilient member 21. This position will occur as the outlet body is inserted into a container and brought into contact with the bottom of the container whereby the valve stem 10 will be urged upwards. During this upward movement the lower side of the valve body's head portion will be elevated relative to the valve seat 14 such that it is possible for a liquid to flow from the stem 3 past the valve body 12 and out through the outlet openings 5 as indicated by the dashed arrows. The channel 22 between the upper part of the valve head 15 and the upper part of the cavity has a dimension ensuring that a substantially laminar flow occurs as the liquid passes the cavity inside the outlet body. In this position a beverage such as beer will be dispensed into the container substantially without any generation of foam whereby it is possible very rapidly to fill the container with the beverage.

In FIG. 5 the device is illustrated in the “foam generating” mode. The device has been forced against the bottom of the cavity such that the resilient member 21 has been deformed (compressed) allowing the upper surface of the valve body's head portion 15 into a position where the channel 22 between the upper part of the valve body's head portion and the upper part of the cavity is very narrow. In this position the liquid passing the channel 22 will experience a substantial pressure loss and as such the CO₂ in the liquid will be relieved whereby foam will be generated. The foam will issue through the outlet openings 5 and eventually bubble to the top of the beverage. With the provision of the resilient member it is as explained above possible to control the amount of foam, i.e. the head of foam that for example a beer will be provided with, without sacrificing the rapid filling of the container in that the normal filling conditions will be present as described above with reference to FIG. 4.

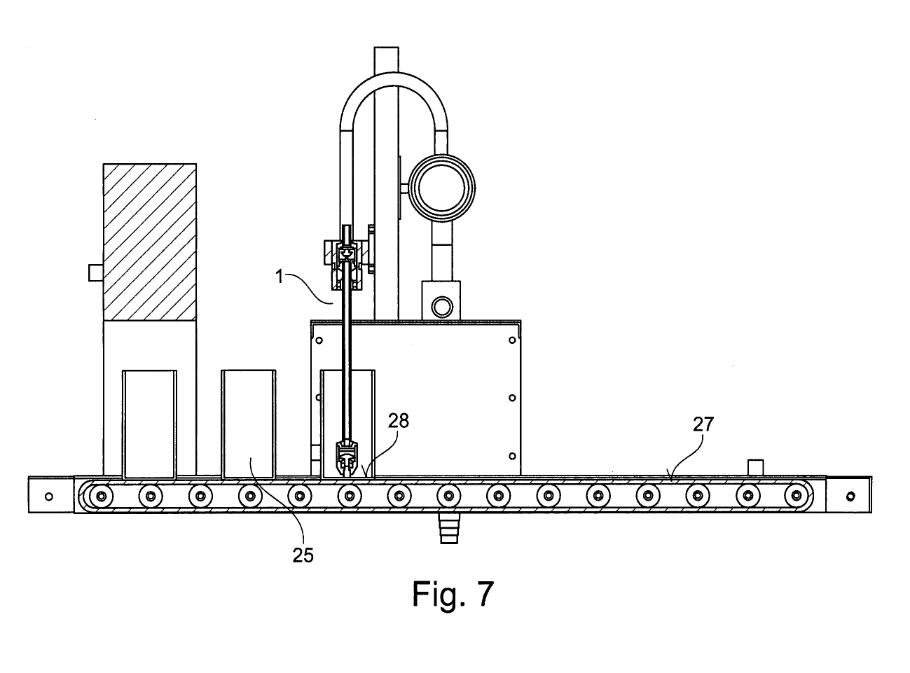

In FIG. 6 is illustrated an apparatus including four dispensers 1 according to the invention. A container 25 is schematically illustrated being brought into contact with one dispenser in the apparatus. The apparatus 26 resembles the well-known dispenser devices already known at present in bars and pubs around the world and as such the present invention does not require substantial alterations or new habits, but simply presents a faster and smoother way of dispensing liquids under pressure. In the embodimeet illustrated in FIG. 6 the container is moved upwards in order to activate the dispenser by displacing the valve stem 10 upwards as already discussed above with reference to FIGS. 3-5.

In FIG. 7 is illustrated an automatic dispenser apparatus where a number of containers 25 are fed from a storage unto a conveyor belt 27. As they travel along the conveyor belt, a plurality of dispensers, in this embodiment one dispensers 1, will be lowered in order to dispense the liquid into the container. For illustrative purposes the dispenser 1 is contact with the bottom 28 of the container. The dispenser 1 is in contact with the bottom 28 of the container and in the process of dispensing a liquid. The conveyor belt 27 may transport the filled containers for further processing or consumption. The dispenser will move vertically up and down and in a batch wise manner fill consecutive containers 25 as these are transported into the filling station by the conveyor 27. It is naturally contemplated that the number of filling dispensers may be larger than one, for example between four and twelve, depending on the set up.

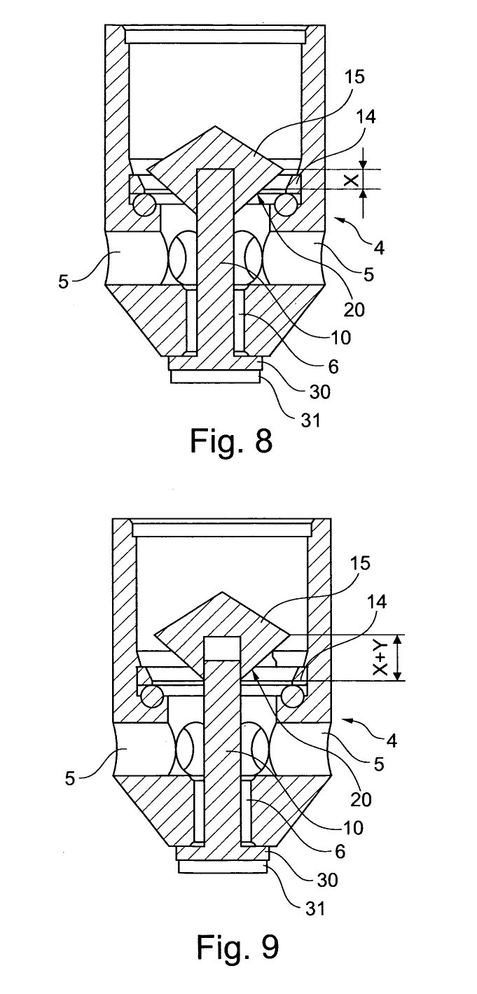

In FIGS. 8 and 9 are illustrated alternative embodiments, of how a modified valve body is designed to provide different outlet properties. A threaded stem member 10 is screwed into the valve body 15. Furthermore the free end of the stem 10 is provided with shoulders 30 having a diameter larger than the opening 6 through which the stem passes in the valve body 4. When the valve is activated by pressing the end of the stem against a surface, typically the bottom of a container, the stems upwards travel is limited by the shoulders 30 engagement with the valve body 4. By adjusting the distance between the shoulders 30 and the valve body 15 the opening between the valve seat 14, and the valve body's 15 engagement surface 20 is adjusted. By proper adjustment it is achieved that a desired amount of foam is generated in the outlet. By adjusting the distance, simply by screwing or unscrewing the stem more or less relative to the valve body 15 the distance and thereby the openings flow properties may be adjusted as desired.

Additionally a resilient layer 31 is attached to the lowermost face of the stem 10, in order to protect the containers into which the device is inserted. Naturally the resilient layer may also have the effect as described above with reference to FIGS. 3 to 5, i.e. be depressing the resilient layer the distance between the valve body and the valve housing may be altered, such that the foam generating properties of the device are adjusted by the operator during dispensation.

In all the illustrated embodiments described above the valve's outlet 5 is indicated as substantially perpendicular to the stems 10 activation direction—generally vertically. This provides an advantage in that the outlet is never blocked by the operator accidentally pushing the outlet into contact with a surface of the container. Had the outlet been in the bottom, as is the case with many prior art devices, the risk of an operator partly or fully blocking the outlet is greatly increased.

The outlet is however also contemplated as being suitable to be placed in the stems activating direction, for example as additional channels surrounding the stems opening 6.

Above the invention has been explained with reference to the liquid being a beer or soft drink, but other fluids which when being dispensed exhibits a tendency to generate foam will also be suitable with the present invention, such as for example various types of soaps, shampoos, other liquid detergents or oil-containing substances.

1. Device for dispensing a liquid under pressure where said device comprises connection means for connecting said device to the source of liquid, and where the device in the opposite end of the connection means has an outlet body which outlet body may be brought into a closed position where no liquid is dispensed, and an open position where liquid is dispensed, which outlet body incorporates a separate valve body cooperating with a valve seat, where said valve body has a head portion and a stem portion, where said stem portion in the closed position extends out of an opening in said outlet body, and where a lower surface of said head portion in the closed position is in contact with said valve seat and in said open position is out of contact with said valve seat, where the head portion is moved from the closed to the open position, by the stem portion engaging an outside surface or the like, mechanically urging the stem and thereby the head portion out of contact with the valve seat, and when the stem is released from its engagement with the outside surface or the like, the head portion is returned into contact with the valve seat.

2. Device according to claim 1, wherein the device has a longitudinal axis where said outlet body is arranged coaxially around said axis, and an inner cavity is arranged inside said outlet body where said cavity has one or more outlet openings downstream from said valve seat and an opening coaxial with the axis for allowing the stem portion of the valve body to extend to the exterior of said outlet body where said cavity has a size allowing the valve body to move freely along the axis a predetermined distance.

3. Device according to claim 1, wherein a resilient member is arranged coaxially with the longitudinal axis on the outside and extending from said outlet body, at least partially surrounding the opening allowing the valve stem to extend from the outlet body.

4. Device according to claim 3, wherein the resilient member is compressible, where when the resilient member engages a surface, the valve head is lifted a predetermined distance from the valve seat, allowing the liquid to flow in a substantially laminar flow, whereas when the resilient member is compressed, the valve head will be in a position near the upper limit of the inner cavity, thereby creating a turbulent flow in the liquid flow.

5. Device according to claim 1, wherein the interior of the device defines a flow area, where said flow area through the device and in particular through said outlet body is between 0.5 to 4 times more preferred between 1 and 2 times the flow area of the inlet in the connection means.

6. Device according to claim 1, wherein an upper part of said valve head is at least partly convex, and that dimples, notches, grooves and/or ridges are provided on said upper part.

7. Device according to claim 1, wherein the connection means comprises a bayonet coupling incorporating an activable one way valve, whereby the device may be separated or connected from the source of liquid.

8. Device according to claim 1, wherein a further stem portion is provided between said outlet body and said connection means, where said stem portion has a liquid conduit.

9. Apparatus for issuing multiple portions of a liquid under pressure incorporating at least one device according to 1, characterised wherein the one or more devices are mounted in a vertically moveable holder along the longitudinal axis of the device, where the apparatus comprises means for moving the one or more devices into a position in a corresponding plurality of containers arranged in an array underneath the devices, where the projecting valve stem of each device engages the bottom of respective containers, whereby the valve head is lifted free from the valve seat and the outlet body issues pressurised liquid into the respective containers, and to a position where the outlet body of the device is above the rim of said containers.

10. Apparatus according to claim 9, wherein a flow meter or a timer is connected to the outflow of liquid from the source, such that only a predetermined amount of liquid is dispensed by the devices.

11. Apparatus according to claim 9, wherein the devices are withdrawn into a washing station in the apparatus, where said station substantially surrounds the outlet body and, if provided, also at least part of the stem, where said washing station either comprises a number of nozzles positioned to wash the outlet body's exterior and stem, the outlet openings, and the inner cavity, or where a source of UV light is arranged for treating all surfaces of the outlet body, the valve body and the stem if provided.
